(19) United States
(12) Patent Application Publication
(10) Pub. No.: US 2007/0270551 A1
(43) Pub. Date: Nov. 22, 2007

(54) Olefin based polymer blend composition

(75) Inventors: Bill R. Bodiford, White Oak, TX (US); Stephen R. Hooker, Longview, TX (US)

Correspondence Address: Patent Counsel;Huntsman Corporation, 10003 Woodloch Forest Drive, The Woodlands, TX, 77380, US

(73) Assignee: Huntsman Polymers Corporation, The Woodlands, TX (US)

(21) Appl. No.: 11/655,405

(22) Filed: Jan. 19, 2007

Related U.S. Application Data
(60) Provisional application No. 60/801,715, filed on May 19, 2006.

(51) Int. Cl. C08L 23/04

(52) U.S. Cl. 525/240

(57) ABSTRACT

A polymer composition is disclosed. In an embodiment, the polymer composition comprises a linear low density polyethylene, a polypropylene polymer, and an elastomer. In some embodiments, the elastomer comprises ethylene and C₄-C₈ alkene.

### CROSS-REFERENCE TO RELATED APPLICATIONS

This application is a non-provisional application that claims the benefit of U.S. Application Ser. No. 60/801,715 filed on May 19, 2006, which is incorporated by reference herein in its entirety.

### STATEMENT REGARDING FEDERALLY SPONSORED RESEARCH OR DEVELOPMENT

Not applicable.

### BACKGROUND OF THE INVENTION

1. Field of the Invention

This invention relates to the field of polymer compositions, and more specifically to the field of a polymer composition comprised of a linear low density polyethylene combined with a polypropylene polymer and an elastomer.

2. Background of the Invention

Polymers have been used in many different consumer product applications. Examples of such applications include liners, roofing membranes, geomembranes, pipes, and the like. The typical polymers in such applications include ethylene propylene diene monomer/copolymers of styrene and butadiene (e.g., elastomers with the butadiene double bonds saturated by hydrogenation).

Drawbacks to such conventional polymers include processing difficulties and financial costs. In addition, applications using such polymers may have reduced puncture resistance. Further drawbacks include applications using such polymers having reduced seam adhesion.

Consequently, there is a need for compositions having improved impact and puncture resistance. Further needs include compositions having low flex properties that are suitable for applications such as a roofing membrane base material.

### BRIEF SUMMARY OF SOME OF THE PREFERRED EMBODIMENTS

These and other needs in the art are addressed in one embodiment by a polymer composition comprising a linear low density polyethylene, a polypropylene polymer, and an elastomer. In an embodiment, the polypropylene polymer comprises a random polymer. In some embodiments, the elastomer comprises ethylene and a C₄-C₈ alkene.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### DETAILED DESCRIPTION OF THE PREFERRED EMBODIMENTS

In an embodiment, a polymer comprises a linear low density polyethylene (LLDPE), a polypropylene polymer, and an elastomer. Such components of the polymer may be combined by any suitable method. For instance, the polymer may be formed by mixing such components in an extruder. It is to be understood that LLDPE refers to a substantially linear polymer with significant numbers of short branches.

In an embodiment, LLDPE may be produced from copolymerization of ethylene with alkylenes. In some embodiments, the alkylenes may be C₄-C₈ alkylenes. Without limitation, examples of alkylenes include butene, pentene, hexene, heptene, octene, or combinations thereof. In one embodiment, the alkylene is octene. Without being limited by theory, octene may provide more entanglements than a lower carbon alkylene. In another embodiment, the alkylene is butene. Without limitation, a commercial example of an LLDPE is LX177, which is commercially available from Huntsman Corporation. Any amount of alkylene may be selected to produce a desirable LLDPE. In some embodiments, the LLDPE contains about 10 wt. % or more alkylene, alternatively about 20 wt. % or more alkylene, and alternatively from about 10 wt. % to about 40 wt. % alkylene, further alternatively from about 15 wt. % to about 30 wt. % alkylene, and alternatively about 20 wt. % alkylene by weight of the LLDPE copolymer. The LLDPE may have a melt index between about 0.3 and about 10.0, and alternatively between about 0.5 and about 5.0 (ASTM D 1238-00 Procedure B). In addition, the LLDPE may have a density between about 0.88 g/ml and about 0.92 g/ml, and alternatively between about 0.89 g/ml and about 0.90 g/ml. The polymer may comprise from about 20 wt. % to about 80 wt. % of LLDPE, alternatively from about 40 wt. % to about 60 wt. % of LLDPE, and alternatively from about 40 wt. % to about 50 wt. % of LLDPE by weight of the polymer. In one embodiment, the polymer contains about 50 wt. % of LLDPE.

The polypropylene polymer may be prepared by any method suitable for use in making the polymer. For instance, non limiting examples of the polypropylene polymer include structures such as atactic, syndiotactic, isotactic, random and/or heterophasic copolymers. In an embodiment, the polypropylene polymer comprises an isotactic polymer. In one embodiment, the isotactic polymer is a C₂-C₄ isotactic polymer. In some embodiments, the isotactic polymer is a random polymer. Without limitation, a commercial example of a random polypropylene polymer is P5M2Z-012, which is available from Huntsman Corporation. In an embodiment, the polypropylene polymer comprises propylene and optionally a C₂-C₆ alkylene, alternatively a random co-polymer propylene and a C₂-C₆ alkylene co-monomer. In an embodiment, the alkylene comprises ethylene. In some embodiments, the polypropylene polymer comprises from about 90.0 wt. % to about 100.0 wt. % propylene, alternatively from about 95.0 wt. % to about 97.0 wt. % propylene. In some embodiments, the polypropylene polymer comprises from about 0.0 wt. % to about 10.0 wt. % alkylene, alternatively from about 3.0 wt. % to about 5.0 wt. % alkylene. The polymer comprises from about 10.0 wt. % to about 50.0 wt. % of polypropylene polymer, alternatively from about 20.0 wt. % to about 40.0 wt. % of polypropylene polymer, further alternatively from about 30.0 wt. % to about 40.0 wt. % of polypropylene polymer, and alternatively from about 25.0 wt. % to about 35.0 wt. % of polypropylene polymer, and further alternatively about 20.0 wt. % of polypropylene polymer by weight of the polymer. In an alternative embodiment, the polymer comprises from about 0.0 wt. % to about 40.0 wt. % of polypropylene polymer.

Embodiments also include the polymer comprising an elastomer. Any elastomer suitable for use with the polymer may be used. In an embodiment, the elastomer comprises ethylene and a C₄-C₈ alkene. The ethylene and C₄-C₈ alkene may be present in any amounts suitable to form an elastomer. In an embodiment, the elastomer comprises from about 55.0 wt. % to about 95.0 wt. % ethylene, alternatively from about 60.0 wt. % to about 90.0 wt. % ethylene, and alternatively from about 70.0 wt. % to about 85.0 wt. % ethylene, and further alternatively from about 60.0 wt. % to about 80.0 wt. % ethylene. In an embodiment, the elastomer comprises from about 5.0 wt. % C₄-C₈ alkene to about 55.0 wt. % C₄-C₈ alkene, alternatively from about 10.0 wt. % C₄-C₈ alkene to about 40.0 wt. % C₄-C₈ alkene, and alternatively from about 20.0 wt. % C₄-C₈ alkene to about 40.0 wt. % C₄-C₈ alkene. Any C₄-C₈ alkene or combinations thereof that are suitable for forming an elastomer may be used. In an embodiment, the C₄-C₈ alkene is a C₆-C₈ alkene, alternatively a C₇-C₈ alkene, and alternative a C₈ alkene. One commercially available elastomer is ENGAGE 8150 polyolefin elastomer available from the Dow Chemical Company of Midland, Mich. In an embodiment, the polymer comprises from about 10.0 wt. % to about 80.0 wt. % of elastomer, alternatively from about 10.0 wt. % to about 50.0 wt. % of elastomer, and alternatively from about 20.0 wt. % to about 40.0 wt. % of elastomer, and further alternatively about 30.0 wt. % of the elastomer. In an alternative embodiment, the polymer comprises from about 0.0 wt. % to about 50.0 wt. % of elastomer.

Embodiments may also include the polymer having at least one filler. Examples of fillers include but are not limited to flame retardants, pigments, talc, CaCO₃, wollastonite, wood pulp, and lubricants. Without limitation, an example of a flame retardant filler is magnesium hydroxide. It is to be understood that appropriate fillers may be selected for desired purposes or applications. For instance, particular fillers may be selected to assist polymers in passing building codes. In some embodiments, pigments and other fillers along with stabilizers may be used to provide desired consumer and performance characteristics. Fillers may be added during extrusion, when the polymers are blended, or any other suitable time. The polymer may contain heat and/or ultraviolet (UV) stabilizers. In some embodiments, the heat and UV stabilizers are suitable for long term weatherability and performance. The heat and UV stabilizers may be adjusted to meet a specific requirement for end use. In an embodiment, these stabilizers may contain from about 0.5% to about 6.0% of the final weight % of the polymer. Without limitation, examples of suitable heat stabilizers may contain a phenolic, phosphite and/or an acid scavenger. UV stabilizers may include but are not limited to the form of UV absorbers, hindered or hydroxylamines, and color concentrates.

The polymer may be cross-linked or non cross-linked. In an embodiment, the polymer is non cross-linked. Without being limited by theory, a non cross-linked polymer may have improved processability. In an embodiment in which the polymer is cross-linked, any cross-linker or combination thereof suitable for use with polymers may be used such as, without limitation, peroxide, silanes and the like.

The polymers may be suitable for a variety of uses. Without limitation, examples of suitable uses include extruded sheet membrane products used for roofing and geomembranes (e.g., pond liners and land fills). The roofing product is generally for use in applications with a low angle or flat roofs that are in wide use in commercial buildings. In such use, the sheets of material are usually overlapped, and an adhesive, hot air, flame, and/or the like may be used to seal the product to prevent water leakage.

Without being limited by theory, the addition of a LLDPE with polypropylene polymer along with the elastomer may provide a very soft and ductile polymer. For instance, such polymers may be ductile at low temperatures. In an embodiment, the polymers are ductile at about −40° C. or below, alternatively about −30° C. or below. In an embodiment, the polymer has a flex modulus from about 20 kpsi (ASTM D790 5 mm Tan) to about 80 kpsi flex, alternatively from about 20 kpsi to about 60 kpsi, and alternatively from about 20 kpsi to about 40 kpsi. Further, without being limited by theory, the elastomer may also be used to provide a suitable melting temperature for hot air or flame sealing of geomembranes to prevent water leaks. For instance, the polymer may be chosen to provide a desired melting temperature for flame sealing or hot air. The polymer may also increase the adhesion between the bottom layer and a scrim in embodiments in which the polymer is used to make a membrane product. In some embodiments, the elastomer may be used to lower the flexibility of a product and help maintain good performance at low temperatures. Further, the elastomer portion of the formulation may also help with the incorporation of fillers acting as a binder.

To further illustrate various illustrative embodiments of the present invention, the following examples are provided.

### EXAMPLES

### Example 1

A polymer was prepared having the composition as shown in Table I

TABLE I

| | | |
|---|---|---|
| LX177 | LLDPE/octene copolymer | 50 wt. % |
| | ~20% or more octene | |
| P5M2Z-012 | random PP ~3.2% ethylene | 20 wt. % |
| | random (co-polymer) | |
| ENGAGE 8150 | ethylene/octene polyolefin | 30 wt. % |
| | elastomer 40% octene content | |

### Examples 2-12

For Examples 2-12, different polymer compositions were prepared. The compositions of the different polymers are shown in Table II. In Table II, P4-005 was a homopolymer polypropylene commercially available from Huntsman Corporation. P5-012 was a random polypropylene polymer commercially available from Huntsman Corporation. AG609 D was a talc filler commercially available from Specialty Minerals.

A series of tests were conducted on the polymer compositions. The results of such tests for Examples 2-7 and 8-12 are shown in Tables III and IV, respectively. All test specimens were injection molded. NB in the table identifies the sample as “no break.”

ASTM methods for the tests are noted below in Table V after the test method. The samples were conditioned for 48 hours at 23° C. in a relative humidity of 50%.

TABLE II

| | Ex. 2 | Ex. 3 | Ex. 4 | Ex. 5 | Ex. 6 | Ex. 7 | Ex. 8 | Ex. 9 | Ex. 10 | Ex. 11 | Ex. 12 |
|---|---|---|---|---|---|---|---|---|---|---|---|
| Component | (Wt. %) | (Wt. %) | (Wt. %) | (Wt. %) | (Wt. %) | (Wt. %) | (Wt. %) | (Wt. %) | (Wt. %) | (Wt. %) | (Wt. %) |
| LX 177 | 60 | 92 | 54 | 100 | 80 | 78 | 50 | 48 | 40 | 45 | 50 |
| ENGAGE | 30 | 5 | 30 | | | | 30 | 30 | 30 | 25 | 30 |
| 8150 | | | | | | | | | | | |
| P4-005 | 10 | | 10 | | | | | | | | |
| P5-012 | | | | | 20 | 20 | 20 | 20 | 30 | 30 | 20 |
| AG609D | | 3 | 3 | | | | | | | | |
| Mineral | | | 3 | | | 2 | | 2 | | | |
| Oil | | | | | | | | | | | |

TABLE III

| Description of | | | | | | |
|---|---|---|---|---|---|---|
| Tests | Ex. 2 | Ex. 3 | Ex. 4 | Ex. 5 | Ex. 6 | Ex. 7 |
| Melt Flow (g/10 min) | 2.24 | 1.86 | 2.29 | 1.78 | 2.12 | 2.44 |
| Flexural | 29,400 | 25,700 | 28,500 | 23,700 | 34,800 | 34,000 |
| Modulus - | | | | | | |
| Tangent (psi) | | | | | | |
| Flexural | 19,000 | 17,600 | 20,000 | 15,600 | 27,400 | 24,600 |
| Modulus - | | | | | | |
| Secant 1% (psi) | | | | | | |
| Notched Izod | 3.89 | 4.64 | 4.24 | 4.28 | 6.8 | 6.42 |
| at 23° C. (ft-lb/in) | | | | | | |
| Type of Break | NB | NB | NB | NB | NB | NB |
| Notched Izod | 10 | 15.2 | 12.6 | 14.4 | 15.8 | 16 |
| −30° C. (ft-lb/in) | | | | | | |
| Type of Break | NB | NB | NB | NB | NB | NB |
| Gardner impact | >320 | >320 | >320 | >320 | >320 | >320 |
| at 23° C. (in-lb) | | | | | | |
| HDT at 66 psi | 47 | 46 | 48 | 48 | 50 | 49 |
| (° C.) | | | | | | |
| Shore D | 36.4 | 40.2 | 37.8 | 39.3 | 43 | 42 |
| Hardness (D) | | | | | | |
| Dynatup | Ductile | Ductile | Ductile | Ductile | Ductile | Ductile |
| −40° C. (ft-lb) | | | | | | |

TABLE IV

| Description of | | | | | |
|---|---|---|---|---|---|
| Tests | Ex. 8 | Ex. 9 | Ex. 10 | Ex. 11 | Ex. 12 |
| Melt Flow (g/10 min) | 1.96 | 2.29 | 1.86 | 1.86 | 2.07 |
| Flexural Modulus - | 32,800 | 31,700 | 32,190 | 31,465 | 30,305 |
| Tangent (psi) | | | | | |
| Flexural Modulus - | 23,900 | 21,300 | 26,535 | 25,375 | 22,185 |
| Secant 1% (psi) | | | | | |
| Notched Izod at | 4.86 | 4.57 | 4.6 | 4.8 | 4.9 |
| 23° C. (ft-lb/in) | | | | | |
| Type of Break | NB | NB | NB | NB | NB |
| Notched Izod at | 15 | 13.6 | 14 | 15 | 15 |
| −30° C. (ft-lb/in) | | | | | |
| Type of Break | NB | NB | NB | NB | NB |
| Gardner impact at | >320 | >320 | >320 | >320 | >320 |
| 23° C. (in-lb) | | | | | |
| HDT at 66 psi | 49 | 49 | 50 | 50 | 49 |
| (° C.) | | | | | |
| Shore D Hardness | 42 | 40 | 43 | 43 | 41 |
| (D) | | | | | |
| Dynatup −40° C. (ft-lb) | Ductile | Ductile | Ductile | Ductile | Ductile |

TABLE V

| Description of Tests | ASTM METHOD |
|---|---|
| Melt Flow (g/10 min) | D 1238-00 Procedure B |
| Flexural Modulus - Tangent (psi) | D 790-00 Procedure A |
| Flexural Modulus - Secant 1% (psi) | D 790-00 Procedure A |
| Notched Izod at 23° C. | D 256-00 Method A |
| (ft-lb/in) | |
| Notched Izod at −30° C. | D 5420-98a |
| (ft-lb/in) | |
| Gardner impact at 23° C. | D 5420-98a |
| (in-lb) | |
| HDT at 66 psi (° C.) | D 648-00a |
| Shore D Hardness (D) | D 2240-00 |
| Dynatup −40° C. (ft-lb) 6.6 m/sec | D 3763-00 |

These examples show a wide variety of compositions of materials that are suitable for membrane type applications. The samples show very good ductility and flexibility. In addition, these formulations are easily processed in an extruder and may incorporate a wide variety and level of fillers. Although the present invention and its advantages have been described in detail, it should be understood that various changes, substitutions and alterations may be made herein without departing from the spirit and scope of the invention as defined by the appended claims.

What is claimed is:

1. A polymer composition comprising:
a linear low density polyethylene;
a polypropylene polymer; and
an elastomer.

2. The polymer composition of claim 1, wherein the linear low density polyethylene comprises a C₄-C₈ alkylene.

3. The polymer composition of claim 1, wherein the linear low density polyethylene comprises octene.

4. The polymer composition of claim 1, wherein the linear low density polyethylene comprises about 10 wt. % or more C₄-C₈ alkylene.

5. The polymer composition of claim 1, wherein the polymer composition comprises from about 20 wt. % to about 80 wt. % of linear low density polyethylene.

6. The polymer composition of claim 1, wherein the polypropylene polymer comprises an atactic, syndiotactic, isotactic, random, heterophasic, or combination thereof structure.

7. The polymer composition of claim 1, wherein the polypropylene polymer comprises a C₂-C₄ isotactic polymer.

8. The polymer composition of claim 7, wherein the isotactic polymer comprises a random polymer.

9. The polymer composition of claim 1, wherein the polypropylene polymer comprises a random co-polymer propylene and a C₂-C₆ alkylene co-monomer.

10. The polymer composition of claim 9, wherein the C₂-C₆ alkylene co-monomer comprises ethylene.

11. The polymer composition of claim 9, wherein the polypropylene polymer comprises from about 0.0 wt. % to about 10.0 wt. % C₂-C₆ alkylene co-monomer.

12. The polymer composition of claim 1, wherein the polypropylene polymer comprises from about 3.0 wt. % to about 5.0 wt. % C₂-C₆ alkylene.

13. The polymer composition of claim 1, wherein the polymer composition comprises from about 10.0 wt. % to about 50.0 wt. % of polypropylene polymer.

14. The polymer composition of claim 1, wherein the polymer composition comprises from about 0.0 wt. % to about 40.0 wt. % of polypropylene polymer.

15. The polymer composition of claim 1, wherein the elastomer comprises ethylene and a C₄-C₈ alkene.

16. The polymer composition of claim 15, wherein the alkene comprises a C₈ alkene.

17. The polymer composition of claim 15, wherein the elastomer comprises from about 55.0 wt. % to about 95.0 wt. % ethylene.

18. The polymer composition of claim 15, wherein the elastomer comprises from about 5.0 wt. % to about 55.0 wt. % C₄-C₈ alkene.

19. The polymer composition of claim 1, wherein the polymer composition comprises from about 10.0 wt. % to about 80.0 wt. % of elastomer.

20. The polymer composition of claim 1, wherein the polymer composition comprises from about 0.0 wt. % to about 50.0 wt. % of elastomer.
